(19) United States
(12) Patent Application Publication
(10) Pub. No.: US 2011/0060922 A1
(43) Pub. Date: Mar. 10, 2011

(54) LICENSE MANAGEMENT SYSTEM

(76) Inventors: Takamitsu Sasaki, Osaka (JP); Satoshi Niwano, Osaka (JP); Takuji Hiramoto, Osaka (JP)

(21) Appl. No.: 12/089,181

(22) PCT Filed: Oct. 3, 2006
(86) PCT No.: PCT/JP2006/319776

§ 371 Date: Apr. 3, 2008

(30) Foreign Application Priority Data
Oct. 5, 2005 (JP) 2005-292892

(51) Int. Cl. G06F 12/14; G06F 21/00

(52) U.S. Cl. 713/194; 726/26

(57) ABSTRACT

A history file that an IC card received from a receiver is confirmed to be a proper history file, so that a repeat input of a license can be prevented. A server (100) which transmits a license that has a usage condition of content includes: a classification key generating unit (101) which generates a classification key that has a history file ID for uniquely identifying each of a plurality of history files on which license-input history on the receiver side is recorded, the license-input history being distributed among the history files; a license issuing unit (103) which issues a license that has the usage condition of content in association with the classification key generated by the classification key generating unit (101); and a server communicating unit (104) which transmits the classification key and the license associated with the classification key.

### TECHNICAL FIELD

The present invention relates to a license management system for managing an input history of a license, which includes a server, a receiver, and an integrated circuit (IC) card, in content distribution systems in which use of an encrypted content is restricted by a usage condition of the license which is specified for each content.

### BACKGROUND ART

Content distribution services which distribute content in real time or on demand using broadcasting and telecommunications are widely available. Specifically, implementation of a content distribution service which is called a server-type broadcasting is planned in Japan.

In the server-type broadcasting, a server transmits an encrypted content and an encrypted license to a receiver, and the receiver receives and accumulates the encrypted content and the encrypted license. The receiver transmits the encrypted license, before reproducing the encrypted content, to an IC card which is a secured module inserted into the receiver, and the IC card receives and decrypts the encrypted license, and manages the decrypted license. The process of which the IC card decrypts the encrypted license and manages the decrypted license is called license-input. The receiver sends, when reproducing the encrypted content, an inquiry to the IC card about whether or not the content can be used. After receiving the inquiry about whether or not the content can be used from the receiver, the IC card judges the availability of the content according to a usage condition included in the license. In the case where the content can be used, the IC card transmits a content key included in the license to the receiver. The receiver decrypts the encrypted content using the content key received from the IC card and reproduces the decrypted content.

The usage condition in a license includes, for example, the number of permitted viewings for a content specified based on a contract of a subscriber. The subscriber uses such a license for viewing the content. The IC card manages the license by subtracting one from the number of permitted viewings each time the subscriber views the content so that the subscriber can not view the content when the number of permitted viewings becomes zero. When the number of permitted viewings can be reset any time to be an unused state by an unauthorized inputting of such a license into the IC card, ultimately content viewing cannot be restricted using the license. When an unauthorized repeat input of the license is possible as stated above, disadvantages arise, for example, that content viewing by a subscriber can not be managed based on a contract.

The IC card records a license-input history so as to prevent such a repeat input of the license. The license-input history is a history of a license which has already been inputted. The IC card prevents the repeat input of a license by refusing the license-input process of a license which has been recorded on the license-input history.

However, the IC card generally has a small storage capacity, thus a large amount of license-input history can not be managed. It is therefore necessary to manage the license-input history by a receiver which has a large storage capacity. However, check of the license-input history and detection of tampering need to be performed by the IC card which is a secured module, since the license-input history can be tampered at the receiver.

Accordingly, the license-input history is divided into plural history files, and the IC card, when inputting a license, receives one history file among plural history files from the receiver, checks the input history, and detects tampering. In the case where the license-input history is made up of the plural history files, however, the IC card needs to store a tampering detection value for each of the history files. However, due to the small storage capacity of the IC card, there is a limitation on the number of the tampering detection values which can be stored in the IC card. Accordingly, the number of history files is limited by the number of the tampering detection values which can be stored in the IC card. When the number of the history files is limited, the number of the license-input history which can be recorded is also limited, and this is not desirable.

There have been conventional techniques for managing the tampering detection value of each data using a tree structure, as the technique for managing plural data which require tampering detection (see, for example, Patent Reference 1). In this tree, a parent node manages a tampering detection value for a child node, so that only the tampering detection value of a root of the tree needs to be stored by the IC card, regardless of the number of data.

With the technique for managing the tampering detection value using the tree structure, the tampering detection value which needs to be stored in the IC card can only be the tampering detection value of the root of the tree, even when the tampering detection value is managed for each of the history files, so that there is no limitation on the number of history files.

In the case where the receiver stores plural history files and the tree which has corresponding tampering detection values, the receiver selects, before reproducing content, a history file among the plural history files, on which an input history of an encrypted license corresponding to the content is recorded, and then transmits the encrypted license, the history file, and the tampering detection value of the history file to the IC card. After receiving the encrypted license, the history file, and the tampering detection value of the history file from the receiver, the IC card performs tampering detection for the history file, checks the input history, and then determines whether or not the inputting process of the encrypted license may be performed.

### Patent Reference 1: Japanese Unexamined Patent Application Publication NO. 2005-32130

### DISCLOSURE OF INVENTION

### Problems that Invention is to Solve

In the conventional techniques, however, only the management of plural independent pieces of data is assumed, but no assumption is made for a method for managing plural pieces of data obtained by dividing a single piece of data, such as a history file which is divided into plural files. Thus, there have been following problems.

In the case where a receiver transmits a history file which is different from a history file on which an input history of an encrypted license is recorded, to the IC card, together with the encrypted license, so as to make a repeat input of the encrypted license which has been used once and whose permitted viewings specified by a usage condition have been used up, the IC card allows the encrypted license to be inputted since the history file which has been received from the receiver has no input history of the encrypted license, and thus an input process is executed. More specifically, the IC card has no means to confirm that the history file received from the receiver is the proper history file corresponding to the license to be inputted. Therefore, there is a problem that an unauthorized repeat input of a license can be conducted by making the IC card refer to an incorrect history file.

The present invention presents a solution to the above-stated conventional problems and aims to provide a license management system in which a history file that an IC card received from a receiver is confirmed to be a proper history file, and a repeat input of a license is prevented.

### Means to Solve the Problems

In order to solve the conventional problems described above, a server according to the present invention, which transmits a license that includes a content usage condition, includes: a classification key generating unit which generates a classification key that includes a history file identification (ID) for uniquely identifying each of a plurality of history files on which a license-input history on a receiver side is recorded, the license-input history being distributed among the history files; a license issuing unit which issues, in association with the classification key generated by the classification key generating unit, a license that includes the content usage condition; and a server transmission unit which transmits the classification key and the license associated with the classification key.

As stated above, the server of the present invention generates a classification key which includes a history file ID and issues a license associated with the generated classification key. By doing so, it is possible to manage on which history file a license-input history is recorded on the receiver side. Accordingly, it is possible to identify the history file into which each license issued by the server is to be written, and to refer to the proper history file when inputting the license. Consequently, a repeat input of the license can be prevented.

Preferably, the server according to the present invention further includes a server storage unit in which classification-key-generating-history information is stored, the information including a history of the classification key generated by the classification key generating unit. The classification key generating unit refers to the classification-key-generating-history information, selects, according to a predetermined rule regarding history file management, the history file ID which indicates the history file into which the license-input history on the receiver side is to be written, generates the classification key which includes the selected history file ID, and record the generated classification key in the classification-key-generating-history information.

As stated above, the server stores the generation history of the classification key. This enables, when generating the classification key, selection of the history file into which the license-input history is to be written according to the predetermined rules regarding history file management, and generation of the classification key which includes the history file ID that indicates the selected history file. Accordingly, it is possible for the server to manage the history file.

Here, the predetermined rules regarding history file management may be: requiring each of the history files to be evenly sized; reducing the number of the history files, or updating data associated with an expired history-storing term.

By generating the classification key which includes the history file ID selected according to such rules, the server can manage the history file corresponding to the receiver.

More preferably, the classification key generating unit refers to the classification-key-generating-history information, selects, according to the predetermined rule regarding the history file management, a write-starting line in the history file into which the license-input history is to be written, generates the classification key which includes the selected write-starting line, and records the generated classification key in the classification-key-generating-history information, the write-starting line indicating a line on which the history is to be written.

Further, the classification key generating unit records, in the classification-key-generating-history information: the generated classification key; the license ID; and in addition, a history storing term in association with one another, the history storing term indicating a term for the license-input history to be stored, the license-input history being associated with the classification key by the license issuing unit.

As stated above, the server generates the classification key which also includes, in addition to a history file into which the license-input history is to be written, a write-starting line on which the history is to be written in the history file. By doing this, it is possible to omit the process for determining where the history is to be written in the history file on the receiver side, while allowing the server more detailed management of the history file. Further, in the case where a history storing term is recorded, it is possible to record a new input history of a license by overwriting unnecessary history information, such as the license-input history which has passed its expiration date. Accordingly, more detailed management of the history file can be conducted by the server, while processes to be performed on the receiver side, such as deleting unnecessary history included in the history file, can be omitted.

More preferably, the classification key generating unit refers to the classification-key-generating-history information, generates, according to the predetermined rule regarding history file management, a management number which indicates an order of the classification key to be generated; generates the classification key which includes the generated management number, and records the generated classification key in the classification-key-generating-history information.

As described above, the server further generates the classification key which includes the management number. This enables the receiver to compare the management number included in the received classification key with the management number of the history included in the history file, and to obtain a license only in the case where it is indicated by the management number that the license is associated with the classification key generated most recently. Thus, it is possible to more strictly manage the input history, thereby preventing a repeat input of the license.

More preferably, the classification key generating unit generates the classification key which includes path information that indicates a path from a root to a leaf of a history management tree which has tampering detection information in a node and the history file in the leaf, and records the generated classification key in the classification-key-generating-history information, the tampering detection information being used for performing tampering detection on the history file.

As described above, in the case where plural history files are managed using the tree structure, the server generates the classification key which includes the path information from the root to a particular history file which is the leaf of the tree. By doing this, it is possible to reduce the process to be performed on the receiver side for locating the history file specified by the server.

More preferably, the server transmission unit transmits the classification key and the license associated with the classification key such that the classification key other than the history file ID and the license other than the license ID are encrypted.

As described above, with encryption before transmission, it is possible to enhance security when transmitting and receiving especially important information such as information related to a contract.

More preferably, the server further includes: a server reception unit which receives at least one of a notification that the history file has been damaged and a notification that the license-input has been rejected; and a Certificate Revocation List (CRL) processing unit which enters, into a CRL, a device which has transmitted the notification received by the server reception unit.

As described above, the server, when notified that the history file is damaged, is capable of judge whether the damage has been caused: by an unauthorized operation by a user of the receiver in which the history file is stored; or by an occurrence of a real failure. Thus, it is possible to prevent a repeat input of the license, which is caused by, for example, an unauthorized corruption and operation of a history file.

Further, a receiver according to the present invention, which receives, from a server, a license that includes a content usage condition, includes: a receiver reception unit which receives a classification key and a license associated with the classification key, the classification key including a history file identification (ID) for uniquely identifying each of a plurality of history files on which a license-input history is recorded, the license-input history being distributed among the history files; a receiver storage unit in which the history files are stored; a history obtaining unit which obtains, from the receiver storage unit, the history file indicated by the history file ID included in the classification key; and a receiver transmission unit which transmits, to an integrated circuit (IC) card attached to the receiver: the history file obtained by the history obtaining unit; and the classification key and the license associated with the classification key which have been received by the receiver reception unit.

An integrated circuit (IC) card according to the present invention, which is attached to a receiver and performs input processing on a license that includes a content usage condition, includes: an IC card reception unit which receives from the receiver: one of a plurality of history files on which a license-input history is recorded, the license-input history being distributed among the history files; a classification key which includes a history file identification (ID) for uniquely identifying each of the history files; and a license associated with the classification key; a history checking unit which compares the history file ID included in the classification key with the history file ID included in the history file; and check whether or not the history file indicated by the history file ID includes the license-input history received by the IC card reception unit in the case where both of the history file ID included in the classification key and the history file ID included in the history file are confirmed to be the same in the comparison, the classification key and the history file having been received by the IC card reception unit; and a license processing unit which performs input processing on a license received by the IC card reception unit in the case where it is confirmed by the history checking unit that the license-input history is not included; and reject input processing on a license received by the IC card reception unit in the case where it is confirmed that the license-input history is included.

The IC card, as described above, checks the history file ID included in the classification key against the history file ID of the received history file itself. By doing this, it is possible to confirm that the received history file is the history file which has been selected by the server, so that it can be verified that the authentic history file corresponding to the license which is the target of the input process has been received. Accordingly, it is possible to prevent a repeat input of a license which is caused by referring to an unauthorized history file which does not correspond to the license that is the target of the input process and by determining that the license has not yet to be inputted.

Preferably, the IC card further includes a tampering detection unit which performs tampering detection on at least one of: the classification key; the license associated with the classification key; the history file; and a node of a history management tree which has tampering detection information in the node and the history file in a leaf, the tampering detection information being used for performing tampering detection on the history file. In the IC card, the IC card reception unit receives from the receiver: the classification key which includes the history file ID for uniquely identifying each of the history files; the license associated with the classification key; and in addition, one of the history files in which license-input history is separately inputted; and the tampering detection information included in the node on a path from a root of the history management tree to the history file, and the history checking unit compares the history file ID included in the classification key with the history file ID included in the history file, the classification key and the history file having been received by the IC card reception unit, only in the case where tampering has not been detected by the tampering detection unit.

As described above, the tampering detection of at least one of the classification key, the license, the history file, and the node is performed. By doing this, it is possible to prevent a repeat input of the license caused by an unauthorized operation, for example, the repeat input of a license caused by making the IC card refer to a tampered history file and incorrectly determine that the already inputted license has not yet to be inputted.

More preferably, the IC card reception unit further receives, from the receiver, the classification key which includes a write-starting line in the history file into which the license-input history is to be written, the write-starting line indicating a line on which the history is to be written; and the history checking unit compares the history file ID included in the classification key with the history file ID included in the history file, the classification key and the history file having been received by the IC card reception unit; and, in the case where both history file IDs match in the comparison, check whether or not the write-starting line includes the license-input history received by the IC card reception unit, the write-starting line being included in the classification key in the history file indicated by the history file ID, the classification key having been received by the IC card reception unit.

Further, the processing history recording unit records the license-input history on the history file by overwriting a line in the history file, the line being indicated by the write-starting line which is included in the classification key.

The IC card receives, the classification key which also includes, in addition to a history file into which the license-input history is to be written, a write-starting line on which the history is to be written in the history file. By doing this, it is possible to record a new license-input history by overwriting unnecessary history information such as license-input history which has passed its expiration date. Thus, it is possible to omit a process, performed by the IC card, of searching and deleting history included in the history file in order to delete unnecessary history.

More preferably, the IC card reception unit further receives, from the receiver, the classification key which includes a management number that indicates a generation order of the classification key for each line of the history file; and the history checking unit compares the history file ID included in the classification key with the history file ID included in the history file, the classification key and the history file having been received by the IC card reception unit; and, in the case where both history file IDs match in the comparison, confirm that the management number included in the classification key received by the IC card reception unit, more than the management number recorded on the write-starting line included in the classification key in the history file indicated by the history file ID, corresponds to the classification key generated most recently, the classification key having been received by the IC card reception unit.

Further, the processing history recording unit records, on the history file, the license-input history together with the management number included in the history file, by overwriting the line in the history file, the line indicated by the write-starting line being included in the classification key.

As described above, the IC card receives the classification key which includes the management number that is given for each line of each of the history files, compares the management number included in the received classification key with the management number included in the write-starting line of the history file, and obtains the license only in the case where it is indicated by the management number that the license is associated with the classification key generated most recently. By doing this, it is possible to more strictly manage the input history, thereby preventing a repeat input of a license.

More preferably, the IC card further includes: a lock unit which locks the input to be performed by the license processing unit in the case where it is notified, from the receiver to which the IC card is attached, that the history file stored by the receiver has been damaged; and an unlock unit which unlocks the lock which has been set by the lock unit in the case where an instruction to unlock the lock is received from the server.

As described above, the IC card locks the process of inputting license in response to a notification from the receiver of damage of the history file. The IC card unlock the process of inputting license in response to an instruction from the server which has determined that the damage has been caused by an occurrence of a real failure, not by an unauthorized operation by a user of the receiver in which the history file is stored. Thus, it is possible to prevent a repeat input which is caused by, for example, an unauthorized corruption and operation of a history file.

With this structure, the IC card can confirm that the history file received from the receiver is the proper history file by comparing the history file ID included in the classification key received from the receiver with the history file ID included in the history file received from the receiver, thereby preventing a repeat input of the license.

Note that the present invention can be achieved not only as a server, a receiver, and an IC card which include above-described characteristic means, but also as: a license management system made up of these units; a transmitting method, a receiving method, and a license-inputting method which include steps that are the characteristic means included in respective units; and a transmitting program, a receiving program, and a license-inputting program which cause a computer to function as characteristic means included in respective units. Further, such programs can be distributed via recording medium such as a Compact Disc Read Only Memory (CD-ROM) and a communication network such as the Internet.

### EFFECTS OF THE INVENTION

The classification key of the present invention is set for each license and designates the history file on which the license-input history is to be recorded. The IC card can confirm that the history file received from the receiver is surely the proper history file corresponding to the encrypted license, by referring to the classification key received from the receiver together with the encrypted license and the history file. This enables the IC card, by checking only one history file among plural divided history files, to obtain the same result as checking the input history of all of the licenses, and to prevent a repeat input of the license.

### BRIEF DESCRIPTION OF DRAWINGS

FIG. 1 illustrates an example of the overview of a server-type broadcasting system in accordance with an embodiment of the present invention.

FIG. 2 is a block diagram illustrating a configuration of devices provided for the server-type broadcasting system in accordance with an embodiment of the present invention.

FIG. 3 illustrates a configuration of license information in accordance with an embodiment of the present invention.

FIG. 4 illustrates a configuration of a history file in accordance with an embodiment of the present invention.

FIG. 5 illustrates a configuration of a classification key issuance history in accordance with an embodiment of the present invention.

FIG. 6 illustrates a configuration of a node of a history management tree in accordance with an embodiment of the present invention.

FIG. 7 illustrates a configuration of a history management tree and history files in accordance with an embodiment of the present invention.

FIG. 8 is a time chart illustrating processes performed by each device provided for the server-type broadcasting system and information transmitted and received between each of the devices.

FIG. 9 is a flow chart of a process performed by the server in accordance with an embodiment of the present invention.

FIG. 10 is a flow chart illustrating the details of an obtaining process S605 of obtaining the encrypted license, the history management tree, and the history file performed by the receiver, and a transmitting process S606 of the same in accordance with an embodiment of the present invention.

FIG. 11 is a flow chart of a process regarding a license-input performed by the IC card in accordance with an embodiment of the present invention.

FIG. 12 is a flow chart illustrating the details of a process of checking the license-input history S904 performed by the IC card in accordance with an embodiment of the present invention.

### NUMERICAL REFERENCES

100 server
101 classification key generating unit
102 server storage unit
103 license issuing unit
104 server communicating unit
110 receiver
111 obtainment history determination unit
112 receiver storage unit
113 history obtaining unit
114 receiver communicating unit
115 content reproducing unit
120 IC card
121 history checking unit
122 IC card storage unit
123 license-input processing unit
124 usage condition determination unit
130 display unit
201 license ID
202 content usage condition
203 classification key
204 content key
205 history file ID
206 write-starting line
207 management number
301 history information
302 history-file-tampering detection value
303 history storing term
501 node ID
502 node-tampering detection value
503 child-node-tampering detection information list

### BEST MODE FOR CARRYING OUT THE INVENTION

An embodiment according to the present invention will be described below with reference to the drawings.

In the present embodiment, a history file on which history of a license-inputting process performed by an IC card is recorded is made up of plural history files. In each history file, an input history of a different license is recorded. The history files and tampering detection information corresponding to each of the history files are managed using a tree structure which is called history management tree.

Here, the tampering detection information is the information used for calculating a tampering detection value. The tampering detection value is the value calculated using an one-way function, more specifically, such value as a hash value. However, other values can be used as long as the value is capable of detecting tampering.

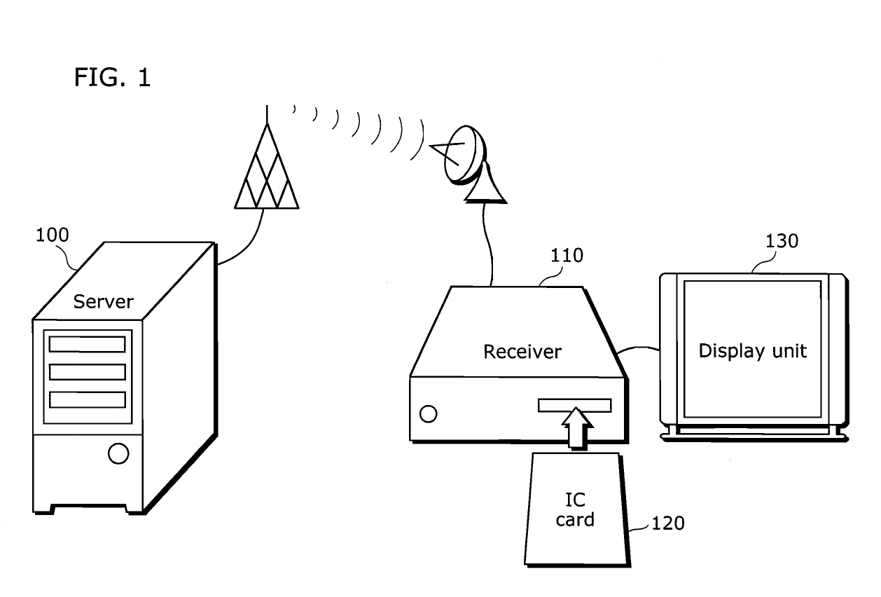

The history management tree and the history file are stored in a receiver 110 described later in FIG. 1. The tampering detection value of a root of the history management tree is stored in an IC card 120 described later in FIG. 1. Further, in addition to the license-input process, update of the history file and calculation of the tampering detection value are performed by the IC card which is an example of secured modules that excels in tamper-resistant characteristics.

Note that the history management tree may manage the history file and the tampering detection value corresponding to the history file. Further, the tampering detection information of the root of the history management tree may be stored in the IC card 120.

In the present embodiment, a description is given using an example which applies the license management system of the present invention to the server-type broadcasting system. Note that the license management system of the present invention can be applied to content communication systems and the like, in addition to the server-type broadcasting systems.

FIG. 1 shows an example of the overview of the server-type broadcasting system in accordance with an embodiment of the present invention. In the server-type broadcasting system according to the embodiment, a license which includes a content-viewing right and so on is transmitted, by a server installed at the broadcasting station which broadcasts content, to a receiver installed at each subscriber who has signed a content-viewing contract.

The server-type broadcasting system according to the present embodiment includes: a server 100; a receiver 110; an IC card 120; and a display device 130.

The server 100 generates information on a license of each subscriber who has signed the viewing-contract for the content provided by the broadcasting station, encrypts the generated information on the license, and transmits an encrypted license and the license information which includes a history file ID indicating the history file into which a license-input history is to be written on the receiver side.

The receiver 110 receives the license information transmitted by the server 100. The IC card 120 can be attached, for example by insertion in this case, to the receiver 110. The license information received by the receiver 110 is transmitted from the receiver 110 to the IC card 120. The IC card 120 performs an input process of decrypting the license included in the received license information and managing the decrypted license.

The display unit 130 is the display used by the subscriber for viewing the content. The subscriber can view the content, by using the license inputted into the IC card 120, within the scope of the viewing right included in the license. In the case where the number of permitted viewings of the content is limited, for example, the IC card 120 manages the subscriber's right for viewing the content, which is spent by viewing the content.

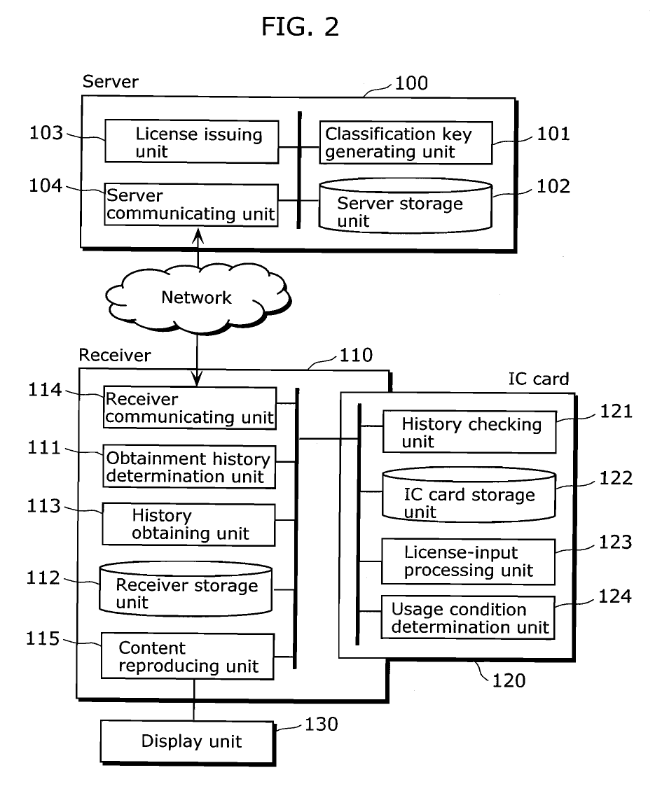

FIG. 2 is a block diagram illustrating a configuration of devices included by the server-type broadcasting system in accordance with the embodiment of the present invention.

The server-type broadcasting system as shown in FIG. 2 includes: the server 100; the receiver 110; the IC card 120; and the display device 130, as in the case of FIG. 1. With regard to the server 100 and the receiver 110, data can be transmitted from the server 100 to the receiver 110 using broadcasting. Note that the server 100 and the receiver 110 only need to be capable of either one-way or two-way communication via transmission medium (network) such as the Internet and the media, and at least only need to be capable of transmitting data from the server 100 to the receiver 110.

The receiver 110 and the display unit 130 are capable of either one-way or two-way communication via transmission medium such as a cable and wireless LAN, and are at least able to transmit data from the receiver 110 to the display unit 130.

The IC card 120 is inserted into the receiver 110 so as to be connected thereto. Note that the IC card 120 has a tamper-resistant structure. The IC card 120, however, may be mounted on the receiver 110 as a secured module which has the tamper-resistant structure. Further, the receiver 110 and the IC card 120 only need to be connected in a manner that they are capable of two-way communication, not only by insertion but via transmission medium such as the cable and radio transmission.

In FIG. 2, the server 100 transmits the encrypted content and the encrypted license to the receiver 100. The receiver 110 receives, from the server 100, and accumulates the encrypted content and the encrypted license.

The receiver 110 transmits the encrypted license, before reproducing the encrypted content, to the IC card 120. The IC card 120 receives and decrypts the encrypted license, and manages the decrypted license. The process of which the IC card 120 decrypts the encrypted license and manages the decrypted license is called license-input.

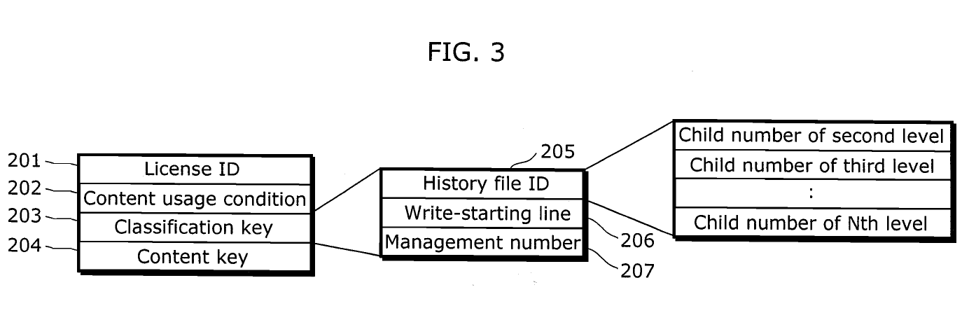

The receiver 110 sends, when reproducing the encrypted content, an inquiry to the IC card 120 on whether or not the content can be used. After receiving the inquiry, from the receiver 110, on whether or not the content can be used, the IC card 120 judges the availability of the content according to a usage condition included in the license. In the case where the content can be used, the IC card 120 transmits, to the receiver 110, a content key 204 which is included in the license and described later in FIG. 3. The receiver 110 decrypts the encrypted content using the content key 204 received from the IC card 120 and reproduces the decrypted content, and displays the reproduced content on the display unit 130.

Further in FIG. 2, the server 100 includes: a classification key generating unit 101; a server storage unit 102; a license issuing unit 103; and a server communicating unit 104.

The classification key generating unit 101 generates, based on a classification key issuance history, a classification key 203 described later in FIG. 3.

The server storage unit 102 stores information necessary for processes of the server, such as the classification key issuance history, the encrypted content, and information for generating a license.

The license issuing unit 103 generates a license based on the classification key 203 generated by the classification key generating unit 101 and information for generating a license which is stored in the server storage unit 102 and encrypts the generated license to generate an encrypted license. However, at least a license ID 201 and the classification key 203 which are included in the license and described later in FIG. 3 are not encrypted.

The server communicating unit 104 transmits the encrypted license and the encrypted content to the receiver 110.

Further in FIG. 2, the receiver 110 includes: an obtainment history determination unit 111; a receiver storage unit 112; a history obtaining unit 113; a receiver communicating unit 114; and a content reproducing unit 115.

The obtainment history determination unit 111 obtains the classification key 203 from the encrypted license stored in the receiver storage unit 112, and determines, based on the classification key 203, a node of a history management tree and the history file which are to be obtained from the receiver storage unit 112.

The receiver storage unit 112 stores: the history management tree; the history file; the encrypted license; the encrypted content; and so on.

The obtainment history determination unit 113 obtains the encrypted license from the receiver storage unit 112 in addition to the node of the history management tree and the history file which are determined by the obtainment history determination unit 111, and transmits the same to the IC card 120. Further, the obtainment history determination unit 113 receives an updated node of the history management tree and an updated history file from the IC card 120, and make the receiver storage unit 112 store the same.

The receiver communicating unit 114 receives, from the server 100, the encrypted license and the encrypted content and make the receiver storage unit 112 accumulate the same.

The content reproducing unit 115 transmits a request for content reproduction to the IC card 120. In the case where the IC card 120 allows content reproduction, the content reproducing unit 115 receives the content key 204 from the IC card 120, decrypts the encrypted content stored in the receiver storage unit 112 using the content key 204, reproduces the decrypted content, and make the display unit 130 display the reproduced content.

Further in FIG. 2, the IC card 120 includes: a history checking unit 121; an IC card storage unit 122; a license-input processing unit 123; and a usage condition determination unit 124.

The history checking unit 121 determines whether to allow or reject the license-input process based on the history file. Further, the history checking unit 121 records the license-input processing history on the history file.

In the IC card storage unit 122, the license, tampering detection information of the history file, tampering detection information of the root of the history management tree, and so on are stored.

The license-input processing unit 123 receives the history management tree, the history file, and the encrypted license from the receiver 110, and performs the license-input process in the case where the history checking unit 121 allows the license-input process.

The usage condition determination unit 124 obtains the license stored in the IC card storage unit 122, determines the usage condition of the content based on the license, obtains the content key 204 from the license in the case where the content is allowed to be used, and transmits the same to the receiver 110.

FIG. 3 illustrates the configuration of license information in accordance with the embodiment of the present invention. The license information is hereinafter simply referred to as “license”.

In FIG. 2, the license includes: a license ID 201; a usage condition 202; a classification key 203; and a content key 204. Further, the classification key 203 includes a history file ID 205, a write-starting line 206, and a management number 207.

The license ID 201 is the identification (ID) for uniquely identifying the license. The usage condition 202 is the usage condition of a content corresponding to the license. The classification key 203 is information to designate the history file on which history of license-input processes is recorded. The content key 204 is a key to decrypt the encrypted content corresponding to the license.

The history file ID 205 indicates the ID of the history file on which history of license-input processes is recorded. The write-starting line 206 indicates the line on which license-input history is recorded in the history file indicated by the history file ID. The management number 207 is the number to determine whether the classification key 203 is a new classification key 203 or an old classification key 203.

The history file ID 205 according to the present embodiment is set so as to indicate a path from the root of the history management tree to the history file. This produces an advantage that there is no need for the history obtaining unit 113 to calculate the path from the root of the history management tree to the history file when obtaining the node of the history management tree and the history file from the receiver storage unit 112. The history file ID 205 is, as shown in FIG. 3, typically made up of a group of child node numbers which are necessary for reaching the history file in each level of the history management tree.

Note that the history file ID 205 does not necessarily have to be set so as to indicate the path from the root of the history management tree to the history file. The history file ID 205 may be any value as long as the value can uniquely identify the history file.

The history checking unit 121, when checking whether or not the history of license-input processes has been recorded on the history file, checks only the line which is indicated by the write-starting line 206. With the write-starting line 206, there is an advantage that there is no need for the history checking unit 121, when checking whether or not the history of license-input processes has been recorded on the history file, to check the entire history recorded on the history file, but only need to check the line indicated by the write-starting line 206.

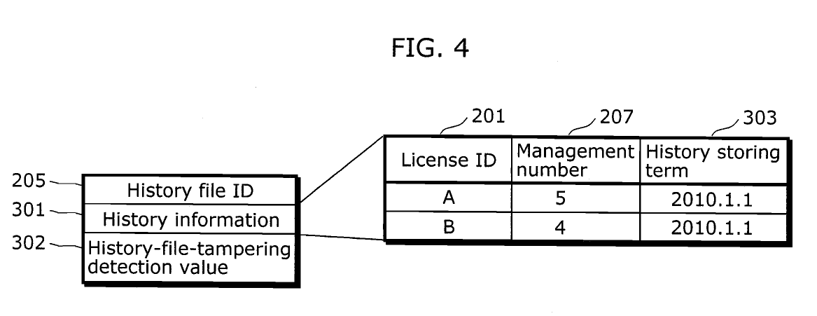

Further, the history checking unit 121, when recording the history of license-input processes on the history file, overwrites the line indicated by the write-starting line 206. With the write-starting line 206, there is an advantage that there is no need for the history checking unit 121 to search and delete, in the history file, the history whose history storing term 303, which will be described later in FIG. 4, has been expired, in order to obtain a line for recording the history thereon in the history file, since the history checking unit 121 only needs to overwrite the line indicated by the write-starting line 206 when recording the history of license-input processes on the history file.

In the present embodiment, the larger the management number 207 is, the later the classification key 203 has been generated. The history checking unit 121 overwrites only the history of license-input processes which has been recorded based on the old classification key 203, for recording the history of license-input processes in which the new classification key 203 is set. By including the management number 207 into the classification key 203, the history checking unit 121 can detect the difference between the new classification key 203 and the old classification key 203, so that it is possible to prevent overwriting the history of license-input processing which has been recorded based on the new classification key 203 with the old classification key 203.

Note that the management number 207 does not necessarily have to be a number, but only need to be the value by which it can be determined whether the classification key 203 is the new classification key 203 or the old classification key 203.

Note that the same advantage can be obtained, without including the classification key 203 in the license, by putting the license and the classification key 203 into a single piece of data and transmits the data to the receiver 110 by the server 100. Further, the classification key 203 may, without being included in a license, be transmitted separately from the license to the receiver 110 by the server 100. In this case, however, classification-key-associating information is necessary, which associates the classification key 203 to the license corresponding to the classification key 203, and the classification-key-associating information is also transmitted from the server 100 to the receiver 110.

Note that the license may include the tampering detection value.

Note that the license may include the history storing term 303 which is the term of which the history of license-input processes should be stored.

Note that the license may include information which forbids repeat obtainment. In this case, a license issuing unit of the server 100 sets, on the license, information which forbids repeat obtainment. Further, the IC card 120 may prevent repeat obtainment of a license by checking the history file, only in the case where information which forbids repeat obtainment of the license is set in the license.

Note that, after an expiration date of a license expired and the license became invalid, the license ID 201 of the invalid license may be reused as a license ID of a different license. In this case, however, it is assumed that the history of input processes of the invalid license is deleted from the history file. It is possible to reduce the number of bytes of the license ID 201 by reusing the license ID 201, and therefore there is an advantage that the size of the license and the size of the history file may be reduced.

Note that the classification key 203 may be used as a value for uniquely identifying a license. The license ID 201 can be omitted in this case.

FIG. 4 illustrates the configuration of the history file in accordance with the embodiment of the present invention.

The history file is a file on which the history of license-input processes is recorded and is stored in the receiver storage unit 112. There are plural history files, each of which is a different history file on which the same input history is not to be recorded. The plural history files are managed by the history management tree which is stored in the receiver storage unit 112.

In FIG. 4, the history file includes a history file ID 205, a history information 301, and a history-file-tampering detection value 302. The history information 301 includes: the license ID 201 of a license of which the input process has already performed; the management number 207 which is included in the classification key 203 used for recording the history; and the history storing term 303 of which the history of license-input processes should be stored. The history-file-tampering detection value 302 is a tampering detection value of the history file.

Note that the history storing term 303 is the value determined by the server 100 and set by the history checking unit 121 of the IC card 120. The history storing term 303 is typically an expiration date not illustrated in FIG. 2, which is set in the license.

However, in such a case where no expiration date exists in the license, the history storing term 303 may be determined in accordance with the rule specified by the server 100, and may be transmitted to the IC card 120 in advance or at the right time.

Note that the history storing term 303 can be used when the IC card 120 deletes the history, however, does not have to be included in the history file in the case where the IC card 120 does not delete history.

Note that in the case where the history management tree manages the tampering detection value of the history file, the history-file-tampering detection value 302 does not have to be included in the history file.

In FIG. 4, an example is illustrated in which the history of input processes of a license which has the license IDs 201 of “A” and “B” is recorded. For example, the input history in which the license ID 201 is “A” indicates that the management number 207 is “5” and the history storing term 303 is “2010.1.1”, and the input history in which the license ID 201 is “B” indicates that the management number 207 is “4” and the history storing term 303 is “2020.1.1”.

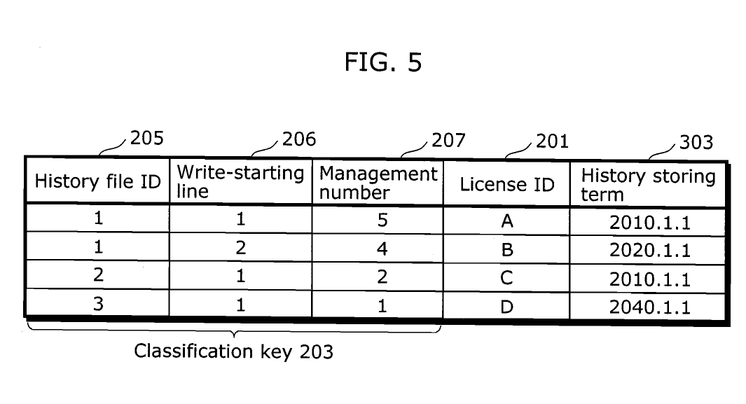

FIG. 5 illustrates the configuration of the classification-key-issuing history in accordance with the embodiment of the present invention.

The classification key issuance history is stored in the server storage unit 102 and includes: the classification key 203 generated by the classification key generating unit 101; the license ID 201 of the license in which the classification key 203 is set; and an issuing history of the classification key on which the history storing term 303 is recorded for each receiver.

In FIG. 5, the classification key issuance history includes: the history file ID 205 which is set, for the receiver 120, in the classification key 203 generated by the classification key generating unit 101; the write-starting line 206; and the management number 207. The classification key issuance history further includes: the license ID 201 of the license with which the classification key 203 is associated by the license issuing unit 103; and the history storing term 303.

FIG. 5 indicates that the classification key 203 in which the history file ID 205 is “1”, the write-starting line 206 is “1” and the management number 207 is “5” has been issued associated with the license in which the license ID 201 is “A” and the history storing term 303 is “2010.1.1”.

In the present embodiment, the classification key issuance history is a history of issuing the classification key which is recorded for each receiver. FIG. 5 indicates the issuance history of the classification key for the receiver 120. There are generally plural contractors. The classification key issuance history includes information, similar to the one indicated in FIG. 5, of each receiver placed at each contractor.

Note that, in the case where plural receivers are placed at one contractor, the classification key issuance history may include the issuance history of the classification key of each contractor. Further, the classification key issuance history may be recorded as the issuance history of the classification key of the server as a whole, not of each receiver or of each contractor.

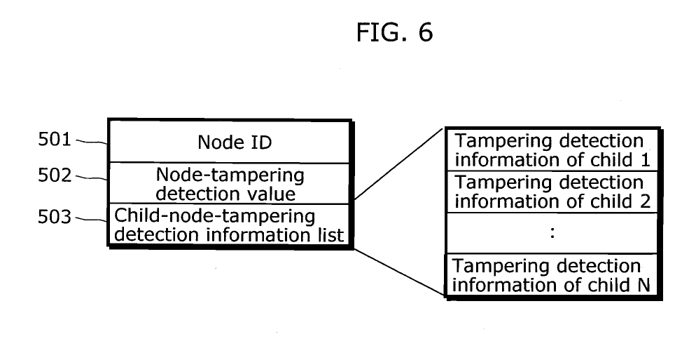

FIG. 6 illustrates the configuration of each node of the history management tree in accordance with the embodiment of the present invention. The history management tree is stored in the receiver storage unit 112.

In FIG. 6, a node includes: a node ID 501; a node-tampering detection value 502; and a child-node-tampering detection information list 503.

The node ID 501 is the ID which uniquely identifies the node in the history management tree.

The node-tampering detection value 502 is a tampering detection value of a node.

The child-node-tampering detection information list 503 is a list of information necessary for performing the child-node-tampering detection on a node in the history management tree.

The child-node-tampering detection information list 503 includes tampering detection information of each child node from node 1 to node N as shown in FIG. 6. Tampering detection information of a child is the information used for calculating the node-tampering detection value 502 of a child. The tampering detection information of a child is typically a numeric value which varies each time the tampering detection value is calculated, however, the present invention is not limited to this.

Note that the tampering detection information of a child may be the child-node-tampering detection value itself. Further, the child-node-tampering detection information list 503 of a node which has the history file in a child is a list of information used for calculating the tampering detection value 302 of the history file.

Note that, in FIG. 6, the child-node-tampering detection information list 503 may include, together with the tampering detection information of a child, information which indicates the corresponding child. Information which indicates the corresponding child includes the child node ID 501 and the number which indicates what number child the child is with respect to the node. By including the information which indicates the corresponding child in the child-node-tampering detection information list 503, there is an advantage that it is possible for the child-node-tampering detection information list 503 to include only the required tampering detection information of the child, without including all the tampering detection information of children from child 1 to child N. By including only the required tampering detection information of the child, the history management tree can be made up of only necessary nodes. Further in this situation, in the case where a new node becomes necessary for the history management tree, the necessary node is added to the history management tree, and the tampering detection information of the node added to the child-node-tampering detection information list 503 which is included in the parent node of the added node is added.

Note that in the case where it is desired to manage the history file by particular management units, such as for every business operator which issues the subject license to be recorded on the history file, plural history management trees may exist. In this case, the IC card storage unit 122 includes the tampering detection value or the tampering detection information, of the root of each history management tree. Further, the root of each history management tree may include information which indicates the place where the tampering detection value or the corresponding tampering detection information of the corresponding root is stored in the IC card storage unit 122. This allows the history checking unit 121 to omit the operation to search, in IC card storage unit 122, the tampering detection value or the tampering detection information of the root of the history management tree.

Note that the history management tree, regardless of whether single or plural, may be stored in the receiver storage unit 112 in a manner so as to be associated with the IC card 120 which includes the tampering detection value or the tampering detection information of the root of the history management tree. Although the history management tree and the IC card 120 are associated with each other typically by including, in the node of the root of the history management tree, an IC card ID which uniquely identifies the IC card 120, other techniques may also be employed. By associating the history management tree with the IC card 120, it is possible to determine the history management tree corresponding to the IC card 120 which is currently inserted, in the case where, for example, plural IC cards 120 have been alternately inserted into the receiver 110 before the currently inserted IC card 120.

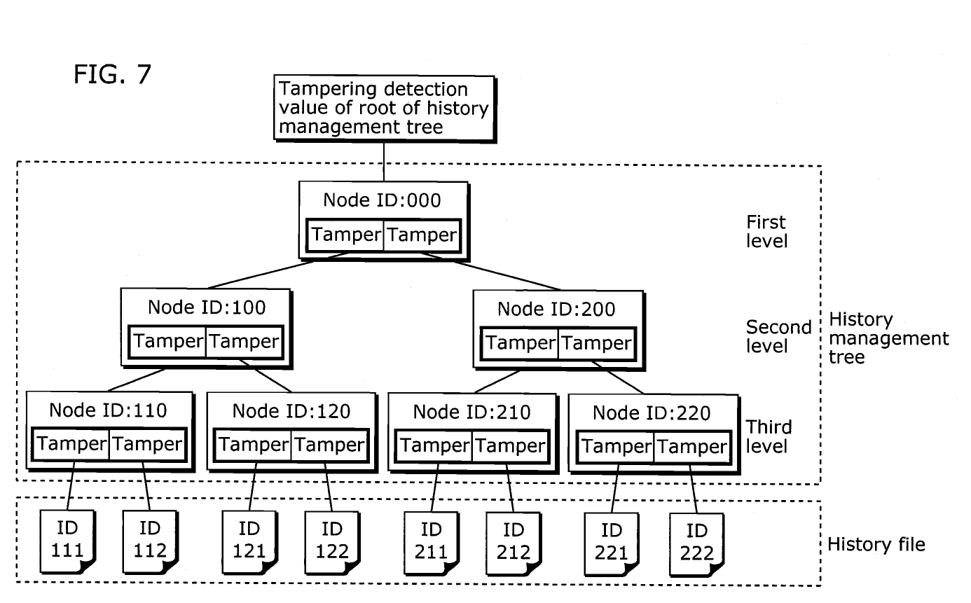

FIG. 7 illustrates the configuration of the history management tree and the history file in accordance with the embodiment of the present invention.

In FIG. 7, the tampering detection value of the root of the history management tree or the tampering detection information of the history management tree is stored in the IC card storage unit 122, and the history management tree and the history files are stored in the receiver storage unit 112. Further in FIG. 7, Tamper indicates the tampering detection information of a child node, a number written in each history file indicates the history file ID 205, and the history file ID 205 indicates the path from the root of the history management tree to the history file. In the three-digit numeric value of the history file ID 205, the hundreds digit indicates what number child node needs to be traced among child nodes of the second level, and the tens digit indicates what number child node needs to be traced among child nodes of the third level. The units digit indicates what number history file among history files included in the node of third level is the corresponding history file.

The node ID 501 of each node in the history management tree is also assigned according to a similar rule. In the case where the value is “0” in each digit of the ID, however, it is indicated that the node is positioned in the level above the level indicated by the “0” digit. Further, it is assumed that the child positioned left is the first child and the child positioned right is the second child in each level.

Here, it is described how to trace the history file which, for example, has the history file ID 205 of “121” from the root of the history management tree in FIG. 7.

First, since the hundreds digit of the history file ID 205 is “1”, the node which has the node ID 501 of “100” is traced from the node which has the node ID 501 of “000”. Next, since the tens digit is “2”, the node which has the node ID 501 of “120” is traced from the node which has the node ID 501 of “100”. Last, since the units digit is “1”, the first child of the node which has the node ID 501 of “120” is the history file of the history file ID 205.

This means that a parent node in the N level of a history management tree corresponding to a history file is the node which has the node ID 501 in which N digit and following digits are set as “0” in the history file ID 205. Accordingly, the root of history management tree can be traced easily from the history file.

For example, the root of the history management tree can be traced from the history file which has the history file ID 205 of “212” by tracing the node which has the node ID 501 of “210”, the node which has the node ID 501 of “200”, and the node which has the node ID 501 of “000”. Although the description has been made with regard to the history file which has the history file ID 205 of “121” here, the same description also applies to history files which have other history file ID 205.

Further in FIG. 7, it is described how to perform tampering detection on the history file and each node. However, the tampering detection on the history file and each node is performed by the IC card 120.

In the case where tampering detection on the history file which has the history file ID 205 of “121” is performed, for example, since the parent node is the node which has the node ID 501 of “120”, the tampering detection value 302 of the history file which has the history file ID 205 of “121” is calculated from the tampering detection information which is held by the node and in the history file which has the history file ID 205 of “121.

Then the calculated value is compared with the history-file-tampering detection value 302 included in the history file which has the history file ID 205 of “121”. When the compared values match, it can be determined that there has been no tampering.

Further, the tampering detection on the tampering detection information included in the node which has the node ID 501 of “120” is performed in a similar manner using the tampering detection information included in the node which has the node ID 501 of “100”. Then, the tampering detection on the tampering detection information included in the node which has the node ID 501 of “100” is performed in a similar manner using the tampering detection information included in the node which has the node ID 501 of “000”.

Lastly, the tampering detection on the tampering detection information included in the node which has the node ID 501 of “000” is performed using the tampering detection information included in the root of the history management tree which is stored in the IC card storage unit 122. As described above, the tampering detection on the history file and each node of the history management tree can be performed, by repeatedly performing the tampering detection on a child node using the tampering detection information included in a parent node.

As stated above, by dividing the history file, it is possible to limit the range to be searched for the history file by the IC card 120, thereby reducing processing load of the IC card 120.

Further, by managing the divided history files using a tree structure, it is possible for the IC card 120 to perform the tampering detection by holding only the tampering detection information of the root of the history management tree, thereby reducing the amount of information which needs to be held by the IC card 120. Further, it is also possible to reduce the processing, performed by the IC card 120, for recalculating the tampering detection value when the history file is updated.

The IC card 120 is, in general, excels in a tamper-resistant feature, but has small storage capacity and low processing ability, thus it is practically beneficial to reduce the amount of information to be stored in the IC card 120 and the processing load of the IC card 120.

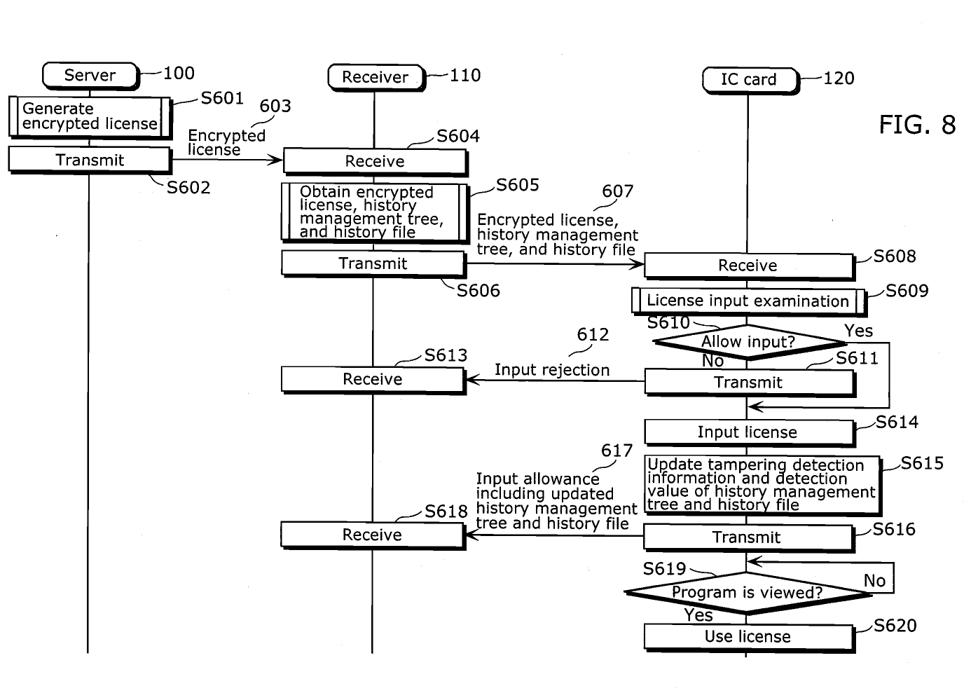

FIG. 8 is a time chart illustrating processes performed by each device provided for the server-type broadcasting system and information transmitted and received between each of the devices. More specifically, this diagram illustrates processes performed by each device and information transmitted and received between each of the devices, from when the server 100 transmits the encrypted license to the receiver 110, and then the receiver 110 transmits the encrypted license to the IC card 120, until the IC card 120 completes the license-input process.

The server 100 generates the encrypted license (S601) and transmits the encrypted license 603 to the receiver 110 (S602).

The receiver 110 receives the encrypted license 603 from the server 100 (S604). The receiver 110 stores the received encrypted license 603 in the receiver storage unit 112, obtains the stored encrypted license from the receiver storage unit 112, obtains the history management tree and the history file based on the information included in the encrypted license (S605), and transmits the obtained information and the encrypted license 607 to the IC card 120 which is attached to the receiver 110 itself (S606).

Note that, when receiving the encrypted license from the server 100 (S604), the receiver communicating unit 114 may transmit the encrypted license to the IC card 120, receive, from the IC card 120, the encrypted license on which cryptographic transformation has been performed by the IC card 120, and then make the receiver storage unit 112 store the same.

At this time, the IC card 120 decrypts the encrypted license which has been received from the receiver 110 and encrypts again to generate an encrypted license on which the cryptographic transformation has been performed. It is noted however that the IC card 120, when generating the encrypted license on which the cryptographic transformation has been performed, does not encrypt at least the license ID 201 and the classification key 203.

Note that, in the case where the receiver 110 stores, in the receiver storage unit 112, the license which has been performed the encryption conversion process, the license issuing unit 103 of the server 100, when generating an encrypted license by generating a license and encrypting the license, may also encrypt the license ID 201 and the classification key 203.

The IC card 120 receives the encrypted license, history management tree, and history file 607 (S608), examine the license-input (S609), and transmits an input rejection 612 to the receiver 110 (S611) in the case where the input is not allowed as a result of the examination (No in S610).

The receiver 110 receives the input rejection 612 (S613) and ends the processing.

Further, in the case where the input is allowed (Yes in S610), the IC card 120 inputs the license (S614), updates the tampering detection information, the tampering detection value of the history management tree, and the history file (S615), and transmits an input allowance 617 which includes the updated information to the receiver 110 (S616).

The receiver 110 receives the input allowance 617 which includes the updated history management tree and the updated history file (S618), overwrites the corresponding node of the history management tree and the history file which have been stored in the receiver storage unit 112, and ends the processing.

Next, the IC card 120 judges whether or not the program is viewed by the subscriber in accordance with the right included in the inputted license (S619). In the case where the IC card 120 judges the program is not viewed by the subscriber (No, in S619), the IC card 120 continues the process to judge whether or not the program is viewed by the subscriber (S619).

In the case where the IC card 120 judges the program is viewed by the subscriber (Yes, in S619), the IC card 120 performs the process for the subscriber to use the license (S620).

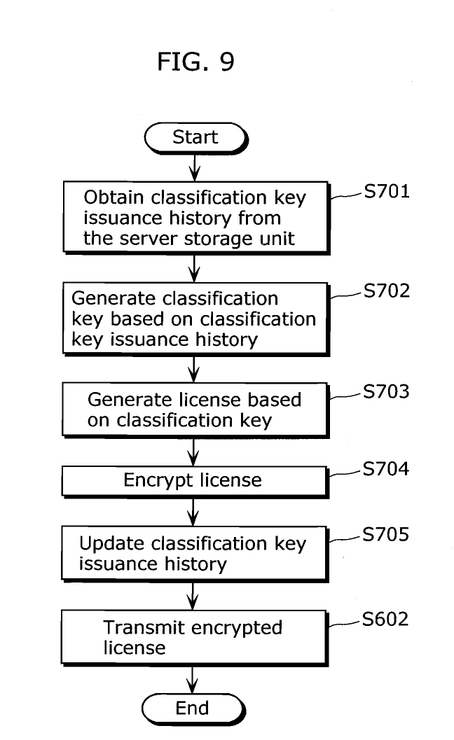

FIG. 9 is a flow chart of a process performed by the server in accordance with the embodiment of the present invention. The encrypted license generation process (S601) as illustrated in FIG. 8, is described in detail in S701 through S705 of this diagram. Further, the encrypted license transmission process (S602) of this diagram is the same process as the one illustrated in FIG. 8, to which the same reference numeral is added.

S701: the classification key generating unit 101 obtains the classification key issuance history from the server storage unit 102.

S702: the classification key generating unit 101 selects, based on the classification key issuance history, the history file ID 205, the write-starting line 206, and the management number 207 of the history file on which the license-input history is recorded. The classification key generating unit 101 generates the classification key 203 based on the history file ID 205, the write-starting line 206, and the management number 207 which have been selected.

S703: The license issuing unit 103 generates a license based on the classification key 203 generated in S702 and information for generating a license which is stored in the server storage unit 102.

S704: The license issuing unit 103 generates an encrypted license by encrypting the license generated in S703.

S705: the classification key generating unit 101 records: the history file ID 205, the write-starting line 206, and the management number 207 of the classification key 203 which has been generated in S702; and the license ID 201 of the license which has been generated in S703 and the history storing term 303, on the classification key issuance history stored in the server storage unit 102.

S602: The server communicating unit 104 transmits the encrypted license to the receiver 110.

Note that, when the classification key generating unit 101 selects, based on the classification key issuance history, the history file ID 205 and the write-starting line 206 of the history file on which the license-input history is to be recorded in S702, the way how to select may be determined according to the rule set in the server 100.

The rules set by the server 100 includes the rule for uniforming the amount of information in each history file, for example, the rule by which the history file carrying less recorded history is preferentially selected for recording history.

Further, the rules set by the server 100 includes the rule for deleting information which has become unnecessary in the history file, for example, the rule of preferentially selecting, for recording history, a line on which the history with an expired history storing term 303 has been recorded.

Further, in the case where the receiver 110 has high processing ability, it is possible to process a history file of a large file size in a short time. In the case where the receiver 110 has low processing ability, it takes a long time to process a history file of a large file size. For that reason, the rules set by the server 100 includes the rule for controlling the file size of the history file according to the processing ability of the receiver 110, for example, the rule by which a file is selected so that the receiver 110 which has high processing ability has the least number of history files on which history is recorded.

Further, the rule set by the server 100 may be selected according to these plural rules. The rule for selecting the history file ID 205 and the write-starting line 206 may, as a matter of course, be changed each time the classification key 203 is generated.

As described above, by selecting the history file on which the license-input history is to be recorded according to the rule set by the server 100, it is possible for the license-input history to be divided into and recorded on appropriate number of history files with the amount of information included in each of the history files being uniform. Accordingly, it is possible to control the load of each receiver for recording the license-input history.

Further, when the classification key generating unit 101 selects the management number 207 based on the classification key issuance history, the way how to select may be determined according to the rule set by the server 100 and the IC card 120.

In the case where the server 100 and the IC card 120 set that the larger the management number 207 is, the later the classification key 203 has been generated, for example, the classification key generating unit 101, when selecting the history file ID 205 and the write-starting line 206 stored in the classification key issuance history in S702, selects, as the management number 207, larger number than the management number 207 which corresponds to the history file ID 205 and the write-starting line 206 stored in the classification key issuance history. Note that, in the case where the history file ID 205 and the write-starting line 206 which have not been recorded on the classification key issuance history are selected, any numeric number, such as “1”, may be selected as the management number 207.

Further in S702, the classification key generating unit 101 may select the history file ID 205 and the write-starting line 206 of the history file on which the license-input history is to be recorded, based on, in addition to the classification key issuance history, a generation schedule of the classification key 203, which is generated from a license generation schedule and the like. Further, the classification key generating unit 101 may select the history file ID 205 and the write-starting line 206 of the history file on which the license-input history is to be recorded, based only on the generation schedule of the classification key 203.

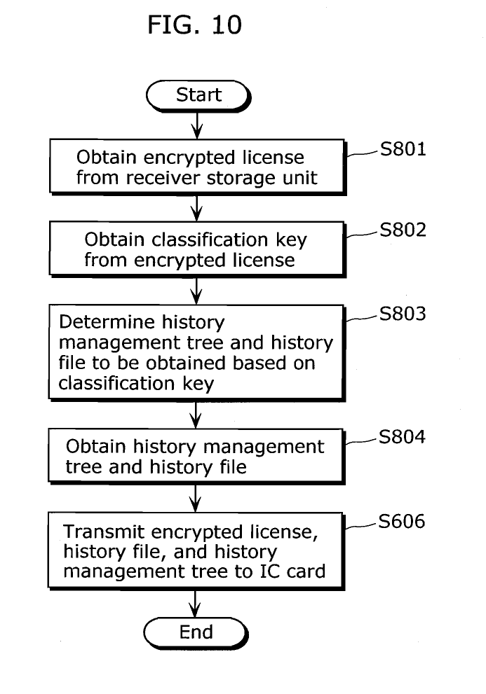

Next, processes performed by the receiver 110 is described in detail with reference to FIG. 10.

FIG. 10 is a flow chart illustrating the details of the obtaining process S605 of obtaining the encrypted license, the history management tree, and the history file performed by the receiver 110, and the transmitting process S606 of the same in accordance with the embodiment of the present invention. The obtaining process of obtaining the encrypted license, the history management tree, and the history file (S605) as illustrated in FIG. 8, is described in detail from S801 through S804 of this diagram. The transmitting process of transmitting the encrypted license, the history management tree, and the history file indicated in this diagram (S606) is the same process as the one illustrated in FIG. 8, to which the same reference numeral is added. This diagram indicates the processes performed by the receiver 110 when the receiver 110 transmits the encrypted license to the IC card 120. The receiver 110 transmits, before reproducing content, a corresponding encrypted license to the IC card 120.

S801: the history obtaining unit 113 obtains the encrypted license from the receiver storage unit 112.

S802: The obtainment history determination unit 111 obtains the classification key 203 from the encrypted license obtained in S801.

S803: The obtainment history determination unit 111 determines, based on the history file ID 205 included in the classification key 203 which has been obtained in S802, the nodes of the history management tree and the history file which are to be obtained. The nodes of the history management tree to be obtained includes every node on the path from the root of the history management tree through the node which has the history file as a child. Further, the history file to be obtained is the history file indicated by the history file ID 205.

S804: the obtainment history determination unit 113 obtains the node of the history management tree and the history file to be obtained which have been determined in S803 from the receiver storage unit 112.

S606: the obtainment history determination unit 113 transmits, to the IC card 120, the encrypted license which has been obtained in S801 and the nodes of the history management tree and the history file which have been obtained in S804.

Note that, when receiving the encrypted license from the server 100, the receiver 110 may immediately transmit the encrypted license to the IC card 120, without storing the encrypted license in the receiver storage unit 112. In this case, the processing starts with S802, without executing S801.

Note that the way of determining, in S803, the nodes of the history management tree to be obtained, based on the history file ID 205 included in the classification key 203, may include: determining the path from the root of the history management tree through the history file using the method described with reference to FIG. 6, and regarding the nodes on the path as the nodes to be obtained; determining the path from the root of the history management tree through the history file by calculation, and regarding the nodes on the path as the nodes to be obtained; determining the path from the root of the history management tree through the history file according to information which indicates the parent node and the child node which has been added to each of the nodes of the history management tree, and regarding the nodes on the path as the nodes to be obtained; and any other determining ways.

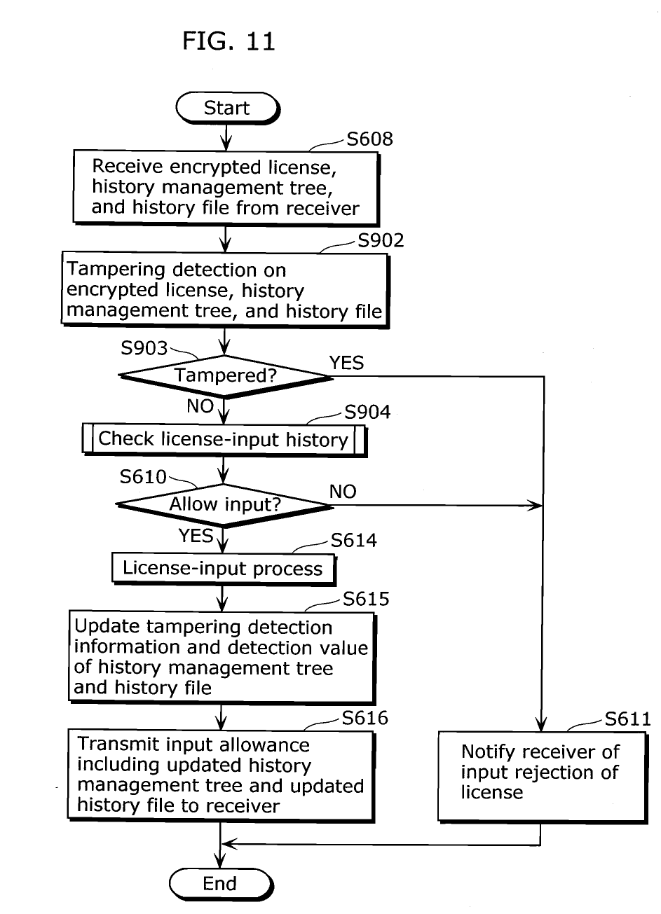

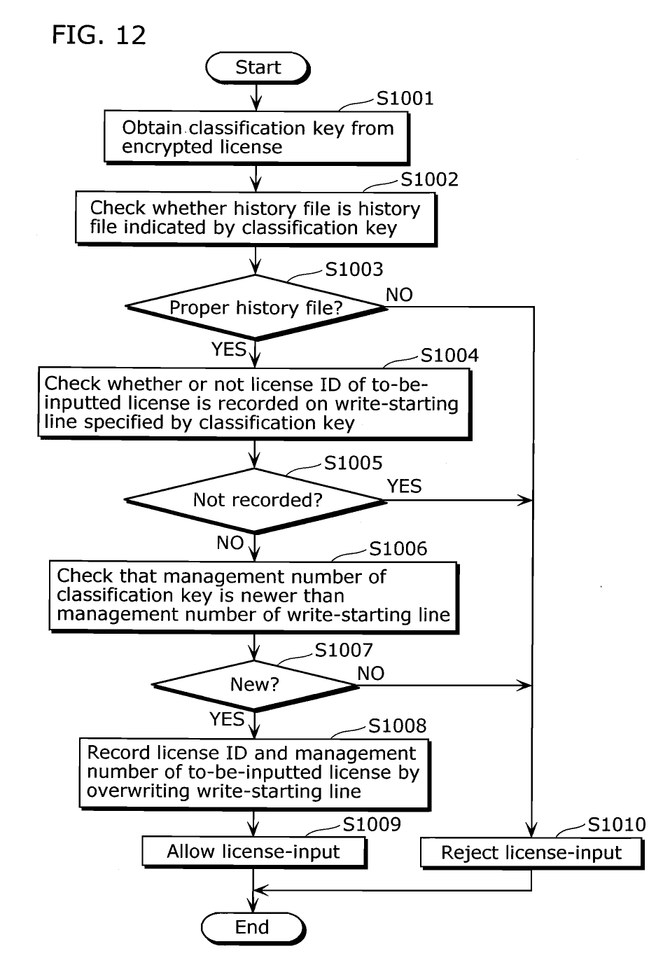

Next, the processing that the IC card 120 performs for the license-input is described in detail with reference to FIG. 11 and FIG. 12.

FIG. 11 is a flow chart of the processing regarding the license-input performed by the IC card in accordance with the embodiment of the present invention. The processing regarding the license-input refers to the processes from a receiving process of the encrypted license, the history management tree, and the history file (S608) through a transmitting process of an input allowance including an updated history management tree and an updated history file (S616) indicated in FIG. 8.

The processes from a tampering detection process of the encrypted license, the history management tree, and the history file (S902) through a license-input history checking process (S904) as shown in FIG. 11 describe in detail of the license input examination (S609) as shown in FIG. 8. The processes of: the receiving process of the encrypted license, the history management tree, and the history file (S608); an input allowance judging process (S610); a transmitting process of the input rejection (S611); and processes from the license input process (S614) through the transmitting process of the input allowance including the updated history management tree and the updated history file (S616) are respectively the same as processes having the same reference numerals as shown in FIG. 8.

S608: the license-input processing unit 123 receives, from the receiver 110, the encrypted license, the node of the history management tree, and the history file.

S902: the license-input processing unit 123 performs the tampering detection on the encrypted license, the node of the history management tree, and the history file which have been received in S608. The tampering detection on the node of the history management tree and the history file is performed using the tampering detection information included in the parent node as described with reference to FIG. 6.

S903: the license-input processing unit 123 performs S611 in the case where tampering has been detected in one of the encrypted license, the node of the history management tree, and the history file in S902, and performs S904 in the case where tampering has not been detected in any of the encrypted license, the node of the history management tree, and the history file in S902.

S904: the history checking unit 121 performs the license-input history checking process which will be described later and determines whether to allow or reject the license-input based on the history file. In the case where the license-input is allowed, the information of the license which is to be inputted is recorded on the history file.

S610: the license-input processing unit 123 performs S614 in the case where the license-input has been allowed in S904, and performs S611 in the case where the license-input has not been allowed in S904.

S614: the license-input processing unit 123 decrypts the encrypted license and manages the decrypted license as the license-input process.

S615: the license-input processing unit 123 calculates the tampering detection value for the history file which has been updated in S904 and sets the value as the history-file-tampering detection value 302. Further, the license-input processing unit 123 sets the tampering detection information which has been used for calculating the tampering detection value of the history file as the child-node-tampering detection information list 503 of the node of the history management tree, which has the history file as the child node. The license-input processing unit 123 calculates the tampering detection value of the node which has the history file as the child node, sets the value as the node-tampering detection value 502 of the node which has the history file as the child node, and sets the tampering detection information used for calculating the tampering detection value as the child-node-tampering detection information list 503 of the parent node. After that, the following processes are repeated: calculating and setting the tampering detection value of a child node; setting the value as the node-tampering detection value 502 of the child node; and setting the tampering detection information used for calculating the set tampering detection value as the child-node-tampering detection information list 503 of the parent node. Note that the tampering detection value of the parent nodes of the history management tree, however, is stored in the IC card storage unit 122.

S616: the license-input processing unit 123 transmits the node of the history management tree and the history file which have been updated in S615 to the receiver 110.

S611: the license-input processing unit 123 notifies the receiver 110 of rejection of the license-input in the case where: tampering has been detected in one of the encrypted license, the node of the history management tree, and the history file in S903; and where the license-input has not been allowed in S610.

FIG. 12 is a flow chart illustrating the details of the license-input history checking process (S904) performed by the IC card in accordance with the embodiment of the present invention.

S1001: the history checking unit 121 obtains the classification key 203 from the encrypted license.

S1002: the history checking unit 121 obtains the history file ID 205 from the classification key 203 which has been obtained in S1001, and compares the history file ID which has been obtained from the classification key 203 with the history file ID 205 of the history file which has been received from the receiver 110.

S1003: the history checking unit 121 performs S1004 in the case where the result of the comparison in S1002 is match, and performs S1010 in the case where the result of the comparison in S1002 is not match.

S1004: the history checking unit 121 obtains the write-starting line 206 from the classification key 203, and checks whether or not the license ID 201 of the encrypted license has been recorded on the line which is specified by the write-starting line 206 in the history file.

S1005: the history checking unit 121 performs S1006 in the case where it has been determined that the license ID 201 of the encrypted license has not been recorded in the check of S1004, and performs S1010 in the case where the license ID 201 of the encrypted license has been recorded on the history file.

S1006: the history checking unit 121 obtains the write-starting line 206 and the management number 207 from the classification key 203, and checks whether or not the management number 207 included in the classification key 203 is a value newer than the value of the management number 207 of the line specified by the write-starting line 206 in the history file. However, it is assumed that the rule which has been set by the server 100 and the IC card 120, which defines that the larger the management number 207 is, the newer the management number 207 is, is followed in the present embodiment.

S1007: the history checking unit 121 performs S1008 in the case where it is determined in S1006 that the management number 207 included in the classification key 203 is newer than the management number 207 of the line specified by the write-starting line 206 included in the classification key 203 in the history file, and performs S1010 in the case where it is not determined the management number 207 included in the classification key 203 is newer.

S1008: the history checking unit 121 obtains the write-starting line 206 and the management number 207 from the classification key 203, and records the license ID 201 of the encrypted license and the management number 207 by overwriting the line specified by the write-starting line 206 in the history file. Further, the history checking unit 121 overwrites the history storing term 303. The value of the history storing term 303 to be recorded by overwriting is set in accordance with the rule designated in advance, and represents, for example, the expiration date designated as the content usage condition 202 of the encrypted license, the term which has been transmitted separately by the server 100, and a predetermined fixed term which starts when the encrypted license is received from the server 100. In the case where the history storing term 303 is not included in the history file, the process of overwriting the history storing term 303 can be omitted.

S1009: the history checking unit 121 allows the license-input.

S1010: the history checking unit 121 rejects the license-input in the following cases: where the history file ID 205 included in the classification key 203 differs from the history file ID 205 included in the history file in S1003; where the license ID 201 of the encrypted license is recorded on the history file in S1005; and where it is not determined that the management number 207 included in the classification key 203 is newer than the management number 207 of the line specified by the write-starting line 206 included in the classification key 203 in the history file in S1007.

Note that in S1006, in addition to comparing the size of management numbers 207, the check may be conducted by determining that a classification key 203 is newer than an other classification key 203 which specifies writing of history written in the line specified by the write-starting line 206 included in the classification key 203. One way of determining a classification key 203 to be newer than an other classification key 203 which specifies writing of history written in the line specified by the write-starting line 206 included in the classification key 203 is to compare the history storing term 303 recorded in the line specified by the write-starting line 206 included in the classification key 203 with the expiration date designated as the content usage condition 202 of the encrypted license and, in the case where the history storing term 303 expires after the expiration date, the classification key 203 is determined to be newer than the other classification key 203 which specifies writing of history written in the line specified by the write-starting line 206 included in the classification key 203.

Note that the license-input processing unit 123 may decrypt the encrypted license and temporarily store the decrypted license in S614 of FIG. 11, and further temporarily store the tampering detection value of the parent node of the history management tree in step S615. In this case, the receiver 110 receives the updated node of the history management tree and the updated history file from the IC card 120, store the same in the receiver storage unit 112, and then notifies the IC card 120 of completion of storage of the updated node of the history management tree and the updated history file. The IC card 120, after receiving the notification, starts the management of the license which has been temporarily stored, and stores, in the IC card storage unit 122, the tampering detection value of the parent node of the history management tree which has been temporarily stored.

Note that, in S611 of FIG. 11, the license-input processing unit 123 of the IC card 120 may notify the server 100 of rejection of the license-input in the case where the license-input is rejected. The server 100, when notified of rejection of the license-input by the IC card 120, in accordance with the predetermined rule, may enter the IC card 120 which has notified the server 100 of rejection of the license-input into a Certificate Revocation List (CRL) and perform a revoke operation, or may record an IC card ID which uniquely identifies the IC card 120.

Note that, in the case where the history management tree or the history file stored in the receiver storage unit 112 has been damaged, the receiver 110 may transmit, to the server 100, a notification that the history management tree or the history file has been damaged. Further, the notification that the history management tree or the history file has been damaged may be transmitted from the receiver 110 to the IC card 120, and then be transmitted from the IC card 120 to the server 100.

In the case where the server 100 is notified that the history management tree or the history file has been damaged, the server 100 may, in accordance with the predetermined rule, enter the receiver 110 or the IC card 120 which has notified the server 100 that the history management tree or the history file has been damaged into the CRL and perform a revoke operation, or may perform an operation for a recovery work by notifying the receiver 110 or the IC card 120 of allowance to delete and reproduce the history management tree or the history file.

Further, in the case where the IC card 120 is notified that the history management tree or the history file has been damaged, the IC card 120 may lock the process of inputting license from the receiver 110 and unlock in response to an instruction from the server via broadcasting or telecommunications. This enables the server to decide what measure to take in the case where the history management tree or the history file is damaged. Thus, it is possible to prevent an unauthorized access by a user through the receiver 110 to the IC card 120.

Note that the obtainment history determination unit 111 may be included in the IC card 120, not in the receiver 110. In this case, the receiver 110 transmits only the encrypted license to the IC card 120. Then the obtainment history determination unit 111 of the IC card 120 which has received the encrypted license obtains the classification key 203 from the encrypted license, and transmits at least the history file ID 205 included in the classification key 203 to the receiver 110. The obtainment history determination unit 113 of the receiver 110 which has received at least the history file ID 205 of the classification key 203 obtains the node of the history management tree and the history file based on the received information and transmits, to the IC card 120, the obtained node of the history management tree and the history file. At this time, the IC card 120 holds the history file and the node of the history management tree which are correspond to the encrypted license, and the subsequent processes are the same as the ones in the case where the obtainment history determination unit 111 is included in the receiver 110.

Note that, in the case where the obtainment history determination unit 111 is included in the IC card 120, not in the receiver 110, the license ID 201 and the classification key 203 of the encrypted license may be encrypted, and the obtainment history determination unit 111 included in the IC card 120 decrypts the encrypted license before obtaining the classification key 203 from the encrypted license.

### INDUSTRIAL APPLICABILITY

The license-input history management system according to the present invention is a system in which the server sets a classification key in a license, the receiver decides the necessary history file based on the classification key, and the IC card properly checks whether the history file is the necessary history file using the classification key, and is useful as the license-input history management system for preventing a repeat input of a license in a content distribution system in which use of an encrypted content is restricted by a license usage condition which is specified for each content.

The license-input history management system according to the present invention is also applicable, in the case where data which needs to be performed tampering detection is divided into plural pieces of data and stored in a module which is not secured and a secured module obtains only the necessary divided data appropriately from the not-secured module, to a data management system and a data utilizing system in which a secured module properly checks whether the data is the necessary data and the tampering detection is performed only on the necessary divided data.

1-32. (canceled)

33. A server which transmits a license that includes a content usage condition, said server comprising:
a classification key generating unit operable to generate a classification key which includes a history file identification (ID) for uniquely identifying each of a plurality of history files on which a license-input history on a receiver side is recorded, the license-input history being distributed among the history files;
a license issuing unit operable to issue, in association with the classification key generated by said classification key generating unit, a license that includes the content usage condition; and
a server transmission unit operable to transmit the classification key and the license associated with the classification key.

34. The server according to claim 33, further comprising
a server storage unit in which classification-key-generating-history information is stored, the information including a history of the classification key generated by said classification key generating unit,
wherein said classification key generating unit is operable to: refer to the classification-key-generating-history information; select, according to a predetermined rule regarding history file management, the history file ID which indicates the history file into which the license-input history on the receiver side is to be written; generate the classification key which includes the selected history file ID; and record the generated classification key in the classification-key-generating-history information.

35. The server according to claim 34,
wherein said classification key generating unit is operable to refer to the classification-key-generating-history information, and further operable to: select, according to the predetermined rule regarding the history file management, a write-starting line in the history file into which the license-input history is to be written; generate the classification key which includes the selected write-starting line; and record the generated classification key in the classification-key-generating-history information, the write-starting line indicating a line on which the history is to be written.

36. The server according to claim 34,
wherein said classification key generating unit is operable to refer to the classification-key-generating-history information, and further operable to: generate, according to the predetermined rule regarding history file management, a management number which indicates an order of the classification key to be generated; generate the classification key which includes the generated management number; and record the generated classification key in the classification-key-generating-history information.

37. The server according to claim 34,
wherein said classification key generating unit is further operable to: generate the classification key which includes path information that indicates a path from a root to a leaf of a history management tree which has tampering detection information in a node and the history file in the leaf; and record the generated classification key in the classification-key-generating-history information, the tampering detection information being used for performing tampering detection on the history file.

38. The server according to claim 34,
wherein said classification key generating unit is operable to record, in the classification-key-generating-history information: the generated classification key; and in addition, a license identification (ID) in association with each other, the license ID being used for uniquely identifying the license which has been associated with the classification key by said license issuing unit.

39. The server according to claim 34,
wherein said classification key generating unit is operable to record, in the classification-key-generating-history information: the generated classification key; the license ID; and in addition, a history storing term in association with one another, the history storing term indicating a term for the license-input history to be stored, the license-input history being associated with the classification key by said license issuing unit.

40. The server according to claim 36,
wherein said classification key generating unit is operable to: refer to the classification-key-generating-history information; select at least one of the history file ID, the write-starting line, and the management number, according to the predetermined rule regarding the history file management; generate the classification key which includes the selected at least one of history file ID, the write-starting line, and the management number; and record the generated classification key in the classification-key-generating-history information, the rule requiring the history files to be evenly sized.

41. The server according to claim 36,
wherein said classification key generating unit is operable to: refer to the classification-key-generating-history information; select at least one of the history file ID, the write-starting line, and the management number, according to the predetermined rule regarding the history file management; generate the classification key which includes the selected at least one of history file ID, the write-starting line, and the management number; and record the generated classification key in the classification-key-generating-history information, the rule requiring the number of the history files to be reduced.

42. The server according to claim 39,
wherein said classification key generating unit is operable to: refer to the classification-key-generating-history information; select at least one of the history file ID, the write-starting line, and the management number, according to the predetermined rule regarding the history file management; generate the classification key which includes the selected at least one of history file ID, the write-starting line, and the management number; and record the generated classification key in the classification-key-generating-history information, the rule requiring information associated with an expired history storing term to be updated.

43. The server according to claim 33,
wherein said server transmission unit is operable to transmit the classification key and the license associated with the classification key such that the classification key other than the history file ID and the license other than the license ID are encrypted.

44. The server according to claim 37, further comprising
a history file ID generating unit operable to generate the history file ID which includes the path information.

45. The server according to claim 33, further comprising:
a server reception unit operable to receive at least one of a notification that the history file has been damaged and a notification that the license-input has been rejected; and
a Certificate Revocation List (CRL) processing unit operable to enter, into a CRL, a device which has transmitted the notification received by said server reception unit.

46. The server according to claim 33, further comprising
a server reception unit operable to receive a notification, from one of a receiver and an IC card, that the history file has been damaged,
wherein said server transmission unit is, in the case where said server reception unit has received the notification, further operable to transmit, to the IC card, at least one of: an instruction to unlock a lock on license-input processing; and an instruction to reproduce the history file, in accordance with a predetermined rule.

47. The server according to claim 33, further comprising:
a server reception unit operable to receive a notification, from one of a receiver and an IC card, that the history file has been damaged; and
a device information recording unit operable to record, in the case where said server reception unit has received the notification, information unique to one of the receiver and the IC card which is a source of the notification.

48. A receiver which receives, from a server, a license that includes a content usage condition, said receiver comprising:
a receiver reception unit operable to receive a classification key and a license associated with the classification key, the classification key including a history file identification (ID) for uniquely identifying each of a plurality of history files on which a license-input history is recorded, the license-input history being distributed among the history files;
a receiver storage unit in which the history files are stored;
a history obtaining unit operable to obtain, from said receiver storage unit, the history file indicated by the history file ID included in the classification key; and
a receiver transmission unit operable to transmit, to an integrated circuit (IC) card attached to said receiver: the history file obtained by said history obtaining unit; and the classification key and the license associated with the classification key which have been received by said receiver reception unit.

49. The receiver according to claim 48,
wherein: said receiver reception unit is further operable to receive the classification key which includes path information that indicates a path from a root to a leaf of a history management tree which has tampering detection information in a node and the history file in the leaf, the tampering detection information being used for performing tampering detection on the history file;
said history obtaining unit is further operable to obtain the tampering detection information held in the node on the path of the history management tree indicated by the path information included in the classification key; and
said receiver transmission unit is further operable to transmit, to the IC card attached to said receiver, the tampering detection information obtained by said history obtaining unit.

50. An integrated circuit (IC) card attached to a receiver, which performs input processing on a license that includes a content usage condition, said IC card comprising:
an IC card reception unit operable to receive from the receiver: one of a plurality of history files on which a license-input history is recorded, the license-input history being distributed among the history files; a classification key which includes a history file identification (ID) for uniquely identifying each of the history files; and a license associated with the classification key;
a history checking unit operable to: compare the history file ID included in the classification key with the history file ID included in the history file; and check whether or not the history file indicated by the history file ID includes the license-input history received by said IC card reception unit in the case where both of the history file ID included in the classification key and the history file ID included in the history file are confirmed to be the same in the comparison, the classification key and the history file having been received by said IC card reception unit; and
a license processing unit operable to: perform input processing on a license received by said IC card reception unit in the case where it is confirmed by said history checking unit that the license-input history is not included; and reject input processing on a license received by said IC card reception unit in the case where it is confirmed that the license-input history is included.

51. The IC card according to claim 50, further comprising
a tampering detection unit operable to perform tampering detection on at least one of: the classification key; the license associated with the classification key; the history file; and a node of a history management tree which has tampering detection information in the node and the history file in a leaf, the tampering detection information being used for performing tampering detection on the history file,
wherein: said IC card reception unit is operable to receive from the receiver: the classification key which includes the history file ID for uniquely identifying each of the history files; the license associated with the classification key; and in addition, one of the history files in which license-input history is separately inputted; and the tampering detection information included in the node on a path from a root of the history management tree to the history file; and
said history checking unit is operable to compare the history file ID included in the classification key with the history file ID included in the history file, the classification key and the history file having been received by said IC card reception unit, only in the case where tampering has not been detected by said tampering detection unit.

52. The IC card according to claim 50, further comprising
a processing history recording unit operable to record, on the history file indicated by the history file ID included in the classification key received by said IC card reception unit, the license-input history performed by said license processing unit in the case where said license processing unit performs input processing on the license received by said IC card reception unit.

53. The IC card according to claim 50,
wherein: said IC card reception unit is further operable to receive, from the receiver, the classification key which includes a write-starting line in the history file into which the license-input history is to be written, the write-starting line indicating a line on which the history is to be written; and
said history checking unit is operable to: compare the history file ID included in the classification key with the history file ID included in the history file, the classification key and the history file having been received by said IC card reception unit; and, in the case where both history file IDs match in the comparison, check whether or not the write-starting line includes the license-input history received by said IC card reception unit, the write-starting line being included in the classification key in the history file indicated by the history file ID, the classification key having been received by said IC card reception unit.

54. The IC card according to claim 53, wherein said processing history recording unit is operable to record the license-input history on the history file by overwriting a line in the history file, the line being indicated by the write-starting line which is included in the classification key.

55. The IC card according to claim 53, wherein:
said IC card reception unit is further operable to receive, from the receiver, the classification key which includes a management number that indicates a generation order of the classification key for each line of the history file; and
said history checking unit is operable to: compare the history file ID included in the classification key with the history file ID included in the history file, the classification key and the history file having been received by said IC card reception unit; and, in the case where both history file IDs match in the comparison, confirm that the management number included in the classification key received by said IC card reception unit, more than the management number recorded on the write-starting line included in the classification key in the history file indicated by the history file ID, corresponds to the classification key generated most recently, the classification key having been received by said IC card reception unit.

56. The IC card according to claim 55,
wherein said processing history recording unit is operable to record, on the history file, the license-input history together with the management number included in the history file, by overwriting the line in the history file, the line indicated by the write-starting line being included in the classification key.

57. The IC card according to claim 52, further comprising
an IC card transmission unit operable to transmit, to the receiver, the history file updated by said processing history recording unit.

58. The IC card according to claim 50, further comprising
an obtainment history determination unit operable to: determine the history file to be obtained based on the history file ID included in the classification key; and transmit, to the receiver, the history file ID of the determined history file to be obtained.

59. The IC card according to claim 50, further comprising:
a lock unit operable to lock the input to be performed by said license processing unit in the case where it is notified, from the receiver to which said IC card is attached, that the history file stored by the receiver has been damaged; and
an unlock unit operable to unlock the lock which has been set by said lock unit in the case where an instruction to unlock the lock is received from the server.

60. The IC card according to claim 50, further comprising:
a lock unit operable to lock the input to be performed by said license processing unit in the case where it is notified, from the receiver to which said IC card is attached, that the history file stored by the receiver has been damaged; and
a history file reproduction unit operable to reproduce the history file in the case where an instruction to reproduce the history file has been received from the server, while the input to be performed by said license processing unit is locked by said lock unit.

61. A transmitting method for transmitting a license that includes a content usage condition, said method comprising:
a classification key generating step of generating a classification key which includes a history file identification (ID) for uniquely identifying each of a plurality of history files on which a license-input history on a receiver side is recorded, the license-input history being distributed among the history files;
a license issuing step of issuing, in association with the classification key generated in said classification key generating step, a license that includes the content usage condition; and
a server transmission step of transmitting the classification key and the license associated with the classification key.

62. A receiving method for receiving, from a server, a license that includes a content usage condition, said method comprising:
a receiver reception step of receiving a classification key and a license associated with the classification key, the classification key including a history file identification (ID) for uniquely identifying each of a plurality of history files on which license-input history is recorded, the license-input history being distributed among the history files;
a history obtaining step of obtaining, from a receiver storage unit in which the history files are stored, the history file indicated by the history file ID included in the classification key; and
a receiver transmission step of transmitting, to an integrated circuit (IC) card: the history file obtained in said history obtaining step; and the classification key and the license associated with the classification key which have been received in said receiver reception step.

63. A license inputting method for inputting a license that includes a content usage condition, said method comprising:
an IC card reception step of receiving, from the receiver: one of a plurality of history files on which license-input history is recorded, the license-input history being distributed among the history files; a classification key which includes a history file identification (ID) for uniquely identifying each of the history files; and a license associated with the classification key;
a history checking step of: comparing the history file ID included in the classification key with the history file ID included in the history file, the classification key and the history file having been received in said IC card reception step; and checking whether or not the history file indicated by the history file ID includes the license-input history received in said IC card reception step in the case where both of the history file ID included in the classification key and the history file ID included in the history file are confirmed to be the same in the comparison; and
a license processing step of: performing input processing on the license received in said IC card reception step in the case where it is confirmed in said history checking step that the license-input history is not included; and rejecting input processing on the license received in said IC card reception step in the case where it is confirmed that the license-input history is included.

64. A transmitting program for transmitting a license that includes a content usage condition, said program causing a computer to execute:
a classification key generating step of generating a classification key which includes a history file identification (ID) for uniquely identifying each of a plurality of history files on which a license-input history on a receiver side is recorded, the license-input history being distributed among the history files;
a license issuing step of issuing, in association with the classification key generated in the classification key generating step, a license that includes the content usage condition; and
a server transmission step of transmitting the classification key and the license associated with the classification key.

65. A receiving program for receiving, from a server, a license that includes a content usage condition, said program causing a computer to execute:
a receiver reception step of receiving a classification key and a license associated with the classification key, the classification key including a history file identification (ID) for uniquely identifying each of a plurality of history files on which license-input history is recorded, the license-input history being distributed among the history files;
a history obtaining step of obtaining, from a receiver storage unit in which the history files are stored, the history file indicated by the history file ID included in the classification key; and
a receiver transmission step of transmitting, to an integrated circuit (IC) card: the history file obtained in the history obtaining step; and the classification key and the license associated with the classification key which have been received in the receiver reception step.

66. A license inputting program for inputting, into an IC card, a license that includes a content usage condition, said program causing a computer to execute:
an IC card reception step of receiving, from the receiver: one of a plurality of history files on which license-input history is recorded, the license-input history being distributed among the history files; a classification key which includes a history file identification (ID) for uniquely identifying each of the history files; and a license associated with the classification key;
a history checking step of: comparing the history file ID included in the classification key with the history file ID included in the history file, the classification key and the history file having been received in the IC card reception step; and checking whether or not the history file indicated by the history file ID includes the license-input history received in the IC card reception step in the case where both of the history file ID included in the classification key and the history file ID included in the history file are confirmed to be the same in the comparison; and
a license processing step of: performing input processing on the license received in the IC card reception step in the case where it is confirmed in the history checking step that the license-input history is not included; and rejecting input processing on the license received in the IC card reception step in the case where it is confirmed that the license-input history is included.

67. A license management system comprising:
a server which transmits a license that includes a content usage condition;
a receiver which receives the license from said server; and
an integrated circuit (IC) card which performs input processing on the license, said IC card being attached to said receiver,
wherein: said server includes: a classification key generating unit operable to generate a classification key which includes a history file identification (ID) for uniquely identifying each of a plurality of history files on which a license-input history on a receiver side is recorded, the license-input history being distributed among the history files;
a license issuing unit operable to issue, in association with the classification key generated by said classification key generating unit, a license that includes the content usage condition; and
a server transmission unit operable to transmit the classification key and the license associated with the classification key;
said receiver includes: a receiver reception unit operable to receive the classification key and a license associated with the classification key which have been transmitted from said server transmission unit;
a receiver storage unit in which the history files are stored;
a history obtaining unit operable to obtain, from said receiver storage unit, the history file indicated by the history file ID included in the classification key; and
a receiver transmission unit operable to transmit, to an integrated circuit (IC) card attached to said receiver: the history file obtained by said history obtaining unit; and the classification key and the license associated with the classification key which have been received by said receiver reception unit; and
said IC card includes: an IC card reception unit operable to receive: the history file; and the classification key and a license associated with the classification key, the history file, the classification key and the license having been transmitted from said receiver transmission unit;
a history checking unit operable to: compare the history file ID included in the classification key with the history file ID included in the history file; and check whether or not the history file indicated by the history file ID includes the license-input history received by said IC card reception unit in the case where both of the history file ID included in the classification key and the history file ID included in the history file are confirmed to be the same in the comparison, the classification key and the history file having been received by said IC card reception unit; and
a license processing unit operable to: perform input processing on a license received by said IC card reception unit in the case where it is confirmed by said history checking unit that the license-input history is not included; and reject input processing on a license received by said IC card reception unit in the case where it is confirmed that the license-input history is included.
